(19) United States
(12) Patent Application Publication
(10) Pub. No.: US 2013/0033162 A1
(43) Pub. Date: Feb. 7, 2013

(54) PORTABLE FOOD PREPARATION CABINET

(71) Applicant: Bruce V. Remus, Madison, SD (US)

(72) Inventor: Bruce V. Remus, Madison, SD (US)

(21) Appl. No.: 13/364,395

(22) Filed: Feb. 2, 2012

Related U.S. Application Data
(60) Provisional application No. 61/439,445, filed on Feb. 4, 2011.

(51) Int. Cl. A47B 96/00; B23P 11/00

(52) U.S. Cl. 312/328; 29/428; 29/426.2

(57) ABSTRACT

The invention is a portable food preparation cabinet, and related processes. The cabinet has a lid, which can be used for food preparation and may be covered with a removable surface. The walls, lid, and bottom enclose a chamber, which can be used to hold food storage containers, food, or food preparation equipment. The lid can be closed for food preparation, or opened to provide access to the chamber. A side of the cabinet may have a coupler, to mate with a corresponding coupler on a food storage container to hold the food storage container in place when the unit is being used for food preparation. Food can be scraped from the lid into a coupled storage container. A sluice in the lid to funnel liquids may be provided. A cabinet may be small and light enough to be taken on a picnic or camping trip.

### CROSS-REFERENCE TO RELATED APPLICATIONS

This application claims the benefit of U.S. Provisional Patent Application No. 61/439,445, filed Feb. 4, 2011 and entitled “Portable Food Preparation Cabinet”.

### FIELD OF THE INVENTION

The present invention relates to equipment for food preparation. More specifically, it relates to a portable cabinet with a cutting surface and couplers to attach food storage containers.

### SUMMARY OF THE INVENTION

The present invention is a portable food preparation cabinet, and a set of related processes that take advantage of the features of the cabinet. The cabinet has a lid that can be used as a cutting board or other food preparation surface. In some embodiments, the lid is covered with a temporary, easily removable, food preparation surface. The temporary surface protects the permanent lid of the cabinet from scratching and wear, and allows a user to quickly change from one food (e.g., fish) to another (e.g, cherries) without washing the surface. The temporary surface may be held in place by a clamp or other retaining device.

The walls, lid, and bottom of the cabinet enclose a chamber. The chamber can be used to hold food storage containers, food, and/or food preparation equipment. The lid can be closed for food preparation, or opened to provide access to the contents of the chamber. One or more sides of the cabinet have food storage container couplers. A food storage container coupler on a cabinet wall will mate with a corresponding coupler on a food storage container to hold the food storage container in place when the unit is being used for food preparation. Preferably, when a food storage container is attached, the coupler will prevent substantial horizontal movement of the container, but will not prevent vertical movement of the container. For example, an upward-facing U-shaped channel coupler on the cabinet can mate with a corresponding downward-facing U-shaped channel coupler on the container, allowing the container to be simply lifted and pulled to detach it.

Food or waste can be conveniently scraped from the lid surface into a container for storage. The lid surface may extend beyond the the walls of the cabinet to facilitate scraping. A sluice may be provided in the lid to capture liquids into a container. Some embodiments have a lid whose material is designed to match a surface upon which the unit rests. When open, the lid may tilt toward a side that has a coupler to facilitate scraping into a food storage container. A sluice might be positioned on the downhill edge for liquid collection. A cabinet may be small enough and light enough to be conveniently taken on a picnic or camping trip. The unit might be fitted with a holder to carry and retain a knife or other utensil.

### BRIEF DESCRIPTION OF THE DRAWINGS

FIG. 1a is a front view of a portable food preparation cabinet with an attached food storage container, showing the cabinet in the closed configuration.

FIG. 1b is a top view of a portable food preparation cabinet with an coupled food storage container.

FIG. 1c is a right side view of a portable food preparation cabinet.

FIG. 2 is a cross-section of a portable food preparation cabinet, at position A-A of FIG. 1, showing the cabinet in an open configuration.

FIG. 3 is a dishwasher safe cutting mat covering the outer surface of the lid of a portable food preparation cabinet.

FIG. 4 is a cross-section through a portion of a portable food preparation cabinet, showing a clamp securing a cutting mat to the upper surface of the lid.

### DETAILED DESCRIPTION OF EXEMPLARY EMBODIMENTS

This description provides embodiments of the invention intended as exemplary applications. The reader of ordinary skill in the art will realize that the invention has broader scope than the particular examples described here.

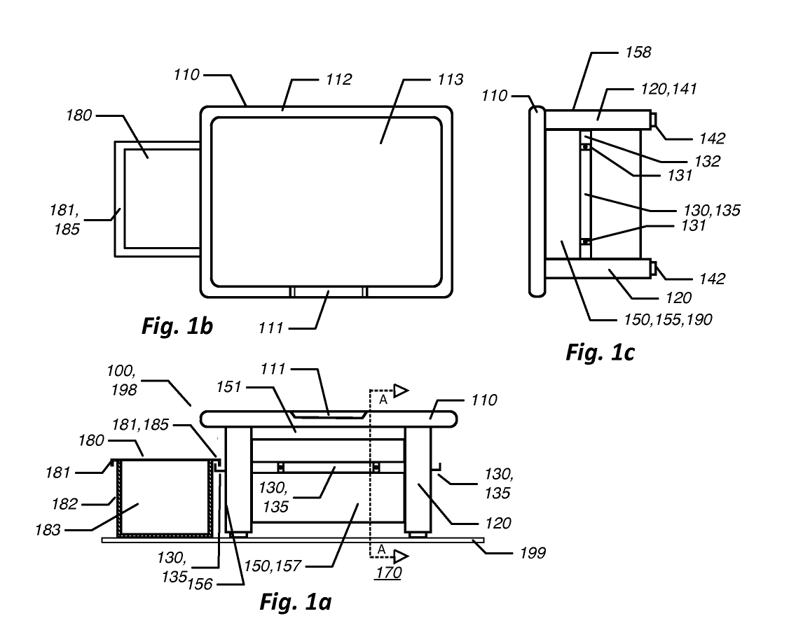

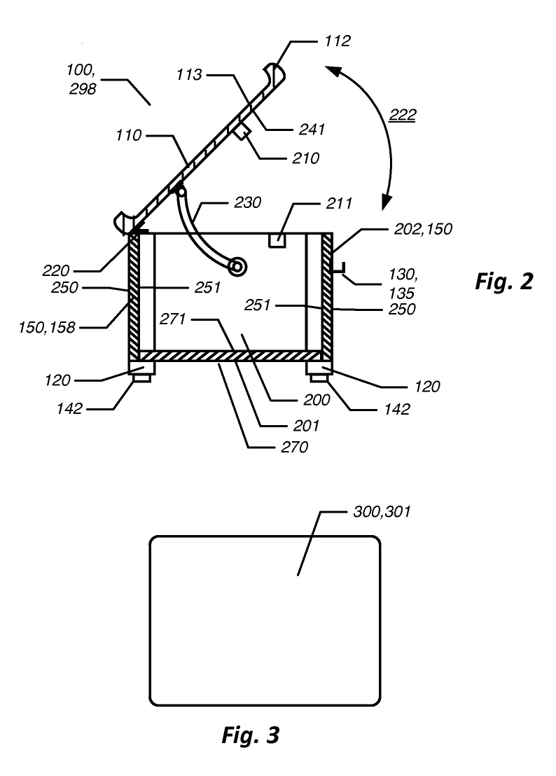

FIG. 1a-1c are front, top, and right side views of a portable food preparation cabinet 100, respectively. FIG. 2 is a cross section through a portable food preparation cabinet 100, from the left side, at the location designated as A-A 170 in FIG. 1a. The illustrated cabinet 100 has an essentially rectangular lid 110, an essentially rectangular bottom 201, and four walls 150. The walls include a front wall 157, a rear wall 158, a left side wall 156, and a right side wall 155. The lid 110, bottom 201, and walls 150 enclose a chamber 200, or interior 200 of the cabinet 100. The cabinet 100 may be equipped with legs 120 at the corners that raise the chamber 200 off of a table top or other horizontal base surface 199 upon which it may rest when in use. Each leg 120 may be equipped on its bottom surface with a foot 142. The foot 142 should preferably be of a material that will not soak up liquids (possibly causing deterioration of the foot 142 or leg 120), that will be soft enough so that the cabinet 100 does not scratch the horizontal base surface 199, and should resist slipping. A rubber or synthetic rubber material, for example, might be used for the foot 142 pads. Felt or velour or other material might also be used.

The lid 110 has a lid outer surface 240, or upper surface, and a lid inner surface 241, or lower surface. Each wall 150 of the cabinet 100, likewise, has a side outer surface 113 and a side inner surface 251. Similarly, the bottom 201 has a bottom outer surface 270 and a bottom inner surface 271. The lid 110 is constructed from material that has sufficient rigidity so it can be used, without being damaged, to cut or chop foods, such as meats and vegetables, with a kitchen knife for preparation of meals or snacks. The rigidity will also be sufficient to withstand pounding such as needed for the preparation of certain foods, as in some chicken recipes, and to withstand kneading and rolling out dough. The combined material and structure of the legs 120, walls 150 and bottom 201 will also be sufficient to withstand such chopping, pounding, and rolling. Preferably, these components will be constructed of hardwood. Alternatively, the components may be constructed of other suitably rigid material, such as plastic, metal, glass, or plexiglass. Different components may be constructed of different materials, and a given component may embody a construction that combines more than one material. The appropriate material for a given embodiment might depend on the application, so, for example, a strong but lightweight material, such as fiberglass or titanium, might be used if the particular cabinet will be carried on someone's back.

The portable food preparation cabinet 100 is designed to work synergistically with food storage containers 180 for the preparation and storage of food, and for cleanup during and after food preparation. Attached to at least to one wall 150 is a storage container coupler 130 configured to couple or attach a food storage container 180 to the cabinet 100. Preferably the front wall 157, the left side wall 156, and the right side wall 155 have such couplers 130, and, because of its relative inaccessibility and to facilitate storage of the unit, the rear wall 158 might not have a storage container coupler 130. Preferably, the food storage container 180 will be a relatively inexpensive product available off-the-shelf from common retailers, such as a Model #L plastic ZIPLOC® container. The food storage containers 180 shown in FIG. 1a have a compartment 183 that is essentially in the shape of a rectangular solid, with a lip 185 (inverted channel, essentially U-shaped) around the perimeter of a top edge, or at least on one side of the food storage container 180. The lip 185 is used as a mating coupler 181, to join the food storage container 180 with the storage container coupler 130 of the portable food preparation cabinet 100.

In the illustrated embodiment, three walls 150 of the cabinet 100 have storage container couplers 130 in the form of U-shaped channels 135. The length, width, and depth of each channel 135 is chosen so that the channel 135 can mate with the lip 185 on container side 182, and the height of the channel 135 may (or may not) be set to correspond to the height of the container 180, so that the container 180 will sit flat on the horizontal base surface 199 when the container 180 is attached to the cabinet 100. If the cabinet 100 has couplers 130 on two or more walls 150, these couplers 130 may be of different types or have various coupler 130 configurations, and could be at various positions to accommodate a variety of container 180 configurations. Mating a lip 185 of a food storage container 180 with a channel 135 on the cabinet 100 is just one example of a coupling mechanism. In essence, all that matters is that a coupler 130 structure on the cabinet 100 must be able to mate with a corresponding mating coupler 181 structure on the food storage container 180. For example, coupling might be done by conventional hooks, by clamps, by devices similar to picture hangers, by magnetism, or by hook and loop fasteners. In some embodiments, the length and/or height of the coupler 130 may be adjustable, in configuration or position, manually by a user of the cabinet 100, either continuously within a range, or discretely. Designs for facilitating such adjustment are well-known to practitioners of ordinary skill in the art.

The coupling should be sufficiently strong to keep the containers 180 from easily slipping around on the horizontal base surface 199, but loose enough that the containers 180 can be detached reasonably easily by a user preparing food with the unit. Preferably, when a container 180 is attached, the coupling mechanism will prevent substantial horizontal movement of the container 180, but will not prevent vertical movement of the container 180. For example, an upward-facing U-shaped channel coupler on the cabinet can mate with a corresponding downward-facing U-shaped channel coupler on the container, allowing the container to be simply lifted and pulled to detach it.

In some embodiments, a wall 150 may have two channel couplers 130, possibly separated laterally by some space. This configuration will allow two food storage containers 180 to be attached adjacent to each other. The space is required if a lip 185 that runs around the entire perimeter of the top of the container 180; such configuration is typical of many commercially available food storage containers 180. Such containers 180 might be of the same height or different heights, with the couplers 130 on the unit positioned accordingly in the vertical.

Preferably a container 180 will be equipped with a cover (not shown), such as a snap-on cover. Ordinarily, when attached to the unit, the cover will be off the container 180 so that food or refuse can be scraped off the cutting surface of the unit into the container 180. Food prepared on the unit can then be easily stored, for example, in a refrigerator or ice chest, within the sealed container when the cover is attached. The easy-on/easy-off configuration of the coupling will facilitate changing out of the containers 180 for preparation of different food types during a preparation session. Also, a container 180 might be used to collect refuse, such as nut shells or meat scraps—again, being able to easily attach and detach the food storage containers 180 makes this convenient. The U-shaped channel 135 arrangement of the illustrated embodiment satisfies this ease of attachment property, with the additional advantage of working with ubiquitously available containers.

In the embodiments shown in FIG. 1a, 1c, and 4, the channel 135 couplers are metal, specifically in this example, aluminum. Couplers might be made of any relatively rigid material, such as metal, plastic, or figberglass. The side includes a recess 132, so that a flange 131 used to attach the channel 135 to the wall 150 does not protrude beyond the remainder of the side outer surface 113. The flanges 131 are attached to the wall 150 with two screws, one on each end. The screws are preferably countersunk into the flange 131.

The chamber 200 of the cabinet 100 should be large enough to hold several containers 180, and possibly various food preparation implements—knives, forks, spoons, spatulas, nutcrackers, can openers, and so forth. The interior or exterior of the cabinet 100 may be equipped with special holders for one or more such implements, such as a holder for one or more knives. Such holders may be attached to one of the interior or exterior surfaces of the device. For example, a knife holder might be attached to the lid inner surface 241, the bottom outer surface 270, to the inner or outer surface of one of the walls. The knife holder might be made a sheath made of leather, or a wooden, stone, composite, or plastic block with slots for one or more knife blades or for other utensils. The knives or other utensils might be secured in the holder by leather or velcro straps, with couplers or snaps to retain the knives, or by dowel pins or other forms of pins.

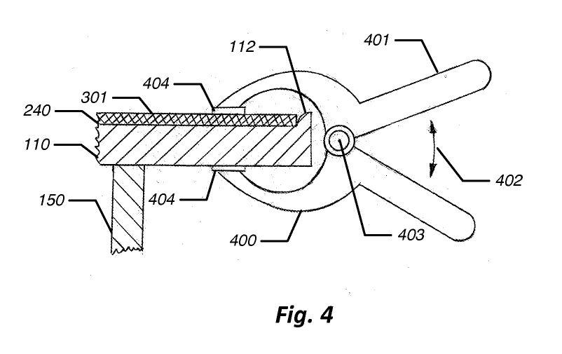

The lid 110 (and, hence, the cabinet 100) should have at least two functional configurations, a closed configuration 198 for cutting, chopping, rolling, or pounding on the lid outer surface 240, and an open configuration 197 to provide access to the interior of the chamber 200. In FIG. 1a-1c and 4, the lid 110 is shown in the closed configuration 198. In FIG. 2, the lid 110 is shown in an open configuration 197. There may be more than one open configuration 197 because, for example, the lid 110 might be able to be open varying amounts. In the embodiment shown a slide 230, with a catch, is attached to a side inner surface 251 and to the lid inner surface 241. The slide 230 allows the lid to move relatively freely between the closed and open configurations, rotating as shown by arrow 222 about the rotation axis of the hinge 220. The slide 230 preferably restricts how far the lid 110 can open, and also preferably contains a simple locking mechanism—in this case, a catch—to keep the lid 110 from unexpectedly and dangerously slamming shut. The embodiment shown includes an upper lid coupling unit 210 attached to the lid 110 and a mating lower lid coupling unit 211 attached to the side inner surface 251 of the right side wall 155, to hold the lid 110 relatively snugly in the closed configuration. While only the right wall 150 is shown in FIG. 2, similar mechanisms (e.g., slide and/or coupling unit/mate) may be on the left side wall 156 as well, or only on the left side wall 156. The specific mechanisms, if any, whereby the lid 110 is secured in the closed or an open configuration may be quite varied within the scope of the invention. In brief, the lid 110 lid should be relatively easy to open and close, but not too easy.

In the embodiment shown in FIG. 2, the rear edge of the lid 110 is attached to the top of the rear wall 158 by a hinge 220. Unlike the hinge 220 shown in the figure, the hinge 220 (or hinges 220, depending on their type) will preferably be recessed into the lid inner surface 241 and the top surface of the rear wall 158.

In some embodiments, the lid 110 might simply lift off from the remainder of the unit, so that it can be set aside. In such embodiments, the lid inner surface 241 may be equipped with downward protruding barriers (not shown), such as a pair of parallel wooden slats cut to fit the depth (front to back), or the width (side to side) of the interior of the cabinet 100, attached to the lid 110 to keep it from slipping to the front, back, or either side. In other embodiments, the lid 110 might be secured to the walls 150 by rails, similar to those commonly used in kitchen cabinetry for utensil drawers. In this case, the lid 110 would remain attached, sliding forward or backward to allow access to the interior of the chamber 200.

In some embodiments, the chamber 200 might not be entirely closed. For example, the bottom “surface” might consist of slats of wood, separated by gaps. As another example, the embodiment shown in FIG. 1a has a small gap 151 between the top of the front wall 157 and the lid inner surface 241, large enough for a person to insert a hand and pry the lid 110 open against resistance from the upper lid coupling unit 210 and lower lid coupling unit 211. In contrast, the front wall 157 in FIG. 2 has no such gap 151.

The lid outer surface 240 is intended to be used, depending on embodiment, as a cutting, chopping, rolling, and pounding board. The lid outer surface 240 might be, for example, wood, plastic, rubber, steel, marble, CORIAN®, MEGANITE®, STARON®, or other synthetic material; in some embodiments, the lid 110 will be composed primarily of synthetic countertop material. The mass of the lid 110 should preferably be no more than 1 kg. A synthetic or natural material might be chosen to visually match the horizontal base surface 199 upon which the cabinet 100 is typically used. In some embodiments, the intended use might be direct. In other embodiments, the lid outer surface 240 might be covered with a temporary removable surface 300, such as the flexible cutting mat 301 shown in FIG. 4. For example, a Flexible Cutting Mat available from COUNTERART® might be employed for this purpose. The use of temporary removable surfaces 300 may serve to protect the lid outer surface 240 of the cabinet 100. The mat 301 might be made from plastic or other synthetic material. Preferably, such a mat 301 will be dishwasher safe. One mat 301 can easily be swapped out for another, allowing, for example, the transition of usage of the unit from one food type to another—say, from preparation of a meat course to preparation of a desert recipe.

Alternatively, a temporary removable surface 300 of glass, plastic, wood, metal, foil, stone, ceramic, fiberglass, or other material—whether rigid or flexible—might be used on the lid outer surface 240.

FIG. 4 illustrates a kind of clamp 400 that might be used to temporarily secure a mat 301 to the lid outer surface 240. The illustrated clamp 400 has a scissor-like V-shaped grip 401. Tension in the mechanism of the grip 401 tends to keep it closed by default. The grip 401 will open by squeezing in the direction opposite to arrow 222. Squeezing will cause pivoting around rotation axis 403 so that the pads 404 will separate, showing the open clamp 400 to be put into place on, or removed from, the lid 110. Most embodiments will utilize two to four clamps 400. Other types of clamps 400 might be used. Preferably, a clamp 400 will be relatively easy for most people to attach, but hold strongly enough so that the temporary removable surface 300 does not slip during ordinary food-processing operations.

The lid 110 might be shaped into, or fitted with, one or more sluices 111 or channels, as shown in FIG. 1a and FIG. 1b, to allow liquid or semi-liquid foodstuffs produced on the surface to be easily collected in a food storage container 180. For example, juices from preparing meat could be collected in this way. Ordinarily the lid 110 will protrude 1 to 8 cm on three sides, allowing food products to be scraped or pushed into the food storage containers 180; the overhang should suffice to prevent liquids and solids that drop vertically off the lid 110 from spilling over either the inner or outer walls of the food storage containers 180.

If the embodiments illustrated by FIG. 1a-2 are combined into a single embodiment, the sluice 111 would be oriented toward the front of the cabinet 100, while the lid 110 tilts toward the back (which in these illustrations does not have a coupler 130 to attach a food storage container 180) when the cabinet 100 is in the open configuration 197. In other embodiments, the lid 110 might tilt toward a wall (either the front, back, or side) having a coupler, so that the tilting cutting surface might assist in draining liquids into the food storage container 180 using the sluice 111.

The lid 110 might have other geometries that are not simply flat. For example, the lid 110 depicted in FIG. 1b is recessed downwards, with a raised shoulder 112 around its circumference, everywhere except at the location of the sluice 111. The surface of the recessed area might be used directly for cutting, or fit with a mat 301. In this case, the shoulder 112 may suffice to keep the mat 301 in place, without clamps or other devices. A cabinet 100 may have a plurality of easily detachable and swappable lids 110 of various useful geometries and topographies. And temporary removable surfaces 300 may be in a variety of materials for particular uses, and may be color coded to correspond to use, such as preparation of meats, vegetables, breads, or deserts.

Some embodiments of the invention are larger and heavier, designed to be relatively permanent kitchen appliances. Such an embodiment may be fitted with a lid 110 to match kitchen decor, such as the material of the horizontal base surface 199. Preferably, however, the unit will be sufficiently small and lightweight to be carried by just one person for, e.g., a picnic, a camping trip, or tailgating at a football game. In this case, the lid 110 should have horizontal dimensions no larger than 50 cm on a side, the height should be no larger than 25 cm. In embodiments intended for such uses, the mass (exclusive of storage containers, utensils, and mats) should be no more than 10 kg, and more preferably no more than 4 kg.

Such a portable embodiment may have one or more additional mechanisms to hold the lid closed, such as hooks, hinges, straps, or locks. The cabinet 100 might be equipped with a handle for carrying. The cabinet 100 might include a strap, that can surround the body of the cabinet 100 to keep the lid 110 closed when the unit is being carried; the strap, which might be made from leather, nylon, or other synthetic material such as commonly used in backpacking gear, might also used to lift and carry the unit. The cabinet 100 might be carried in a bag or backpack, selected to be close to its size and shape.

Preferably, the back edge of the lid 110 will be flush or nearly flush with the rear outer surface 260 of the cabinet 100, as seen in FIG. 1c. This allows for the unit to be stored resting on its rear wall 158, for example, on a shelf such as might be found in a kitchen.

The invention also encompasses processes or methods for using any of aspects or features, as described above, of a portable food preparation cabinet 100, that is itself an embodiment of the invention for example by: (1) preparing food on the lid outer surface 240 or on a mat 301 or other temporary surface on the lid outer surface 240, whether attached or not; (2) opening the lid 110 to place objects in, or remove objects from, the chamber 200; (3) coupling or removing a food storage container 180 from a wall 150 of the cabinet 100; (4) sliding food off the surface into a coupled food storage container 180; (5) fastening the lid 110 with a fastener; (6) storing a cabinet 100, resting on a wall 150, on a shelf or other surface; or (7) carrying a cabinet 100 in a bag or backpack.

Of course, many variations of the above method are possible within the scope of the invention. The present invention is, therefore, not limited to all the above details, as modifications and variations may be made without departing from the intent or scope of the invention. Consequently, the invention should be limited only by the following claims and equivalent constructions.

What is claimed is:

1. A cabinet, comprising:
a) a front wall, a rear wall, a left side wall, a right side wall, a lid, and a bottom, each having an inner surface and an outer surface, and wherein the lid is adapted to being moved between a closed configuration—in which the outer surface of the lid is essentially horizontal and the walls, lid, and bottom enclose a chamber interior to the cabinet, and an open configuration—in which the interior will be exposed; and
b) a storage container coupler, attached to the outer surface of a wall.

2. The cabinet of claim 1, further comprising:
c) a storage container, including a second coupler, mated with the storage container coupler.

3. The cabinet of claim 2, wherein the second coupler is essentially U-shaped in cross-section, and the cross-section opens in a downward direction when the storage container is mated with the storage container coupler and the cabinet is in an ordinary operating position.

4. The cabinet of claim 1, wherein the coupler is essentially U-shaped in cross-section.

5. The cabinet of claim 3, wherein the cross-section is open in an upward direction when the cabinet is in an ordinary operating position.

6. The cabinet of claim 1, further comprising:
c) a hinge connecting one of the walls to the lid; and
d) a slide that secures the lid in an orientation that is tilted relative to the bottom when the cabinet is in the open configuration.

7. The cabinet of claim 1, further comprising:
c) a hinge connecting one of the walls to the lid; and
d) a slide that secures the lid in an orientation that is tilted relative to the bottom when the cabinet is in the open configuration.

8. The cabinet of claim 1, wherein the outer surface of the lid includes an elevated lip along an edge.

9. The cabinet of claim 1, wherein the outer surface of the lid has a perimeter, and the elevated lip extends around the perimeter.

10. The cabinet of claim 1, wherein the outer surface of the lid has a perimeter, and the elevated lip extends around the perimeter except for one segment of the perimeter.

11. The cabinet of claim 1, wherein the lid is primarily composed of synthetic composed of synthetic countertop material.

12. The cabinet of claim 1, wherein the lid extends at least 2 cm outward beyond the wall to which the storage container coupler is attached.

13. The cabinet of claim 1, further comprising:
c) a flexible mat attached to the lid.

14. The cabinet of claim 13, wherein the flexible mat is attached to the lid by a clamp.

15. The cabinet of claim 1, wherein the mass of the cabinet does not exceed 4 kg.

16. A cabinet, comprising:
a) a front wall, a rear wall, a left side wall, a right side wall, a lid, and a bottom, each having an inner surface and an outer surface, and wherein the lid is adapted to being moved between a closed configuration—in which the outer surface of the lid is essentially horizontal and the walls, lid, and bottom enclose a chamber interior to the cabinet, and an open configuration—in which the interior will be exposed; and
b) means for coupling a storage container coupler to the outer surface of a wall.

17. A method, comprising:
a) attaching a food storage container including a first coupler to a cabinet, the cabinet including a front wall, a rear wall, a left side wall, a right side wall, a lid, and a bottom, each having an inner surface and an outer surface, and wherein the lid is adapted to being moved between a closed configuration—in which the outer surface of the lid is essentially horizontal and the walls, lid, and bottom enclose a chamber interior to the cabinet, and an open configuration—in which the interior will be exposed, and further including a second coupler, attached to the outer surface of a wall, the step of attaching mating the first coupler with the second coupler;
b) cutting material on the outer surface of the lid; and
c) pushing or scraping the material off the outer surface of the lid so that the material falls into the food storage container.

18. The method of claim 17, further comprising:
d) detaching the food storage container from the cabinet.

19. The method of claim 18, further comprising:
e) opening the lid of the cabinet and placing the food storage container interior to the cabinet.
